(19) United States
(12) Patent Application Publication
(10) Pub. No.: US 2014/0267183 A1
(43) Pub. Date: Sep. 18, 2014

(54) TOUCH SCREEN INTERFACING DEVICE

(71) Applicant: Anne H. Branch, San Luis Obispo, CA (US)

(72) Inventor: Anne H. Branch, San Luis Obispo, CA (US)

(21) Appl. No.: 13/803,614

(22) Filed: Mar. 14, 2013

(51) Int. Cl. G06F 3/0354; G06F 3/041

(52) U.S. Cl. CPC G06F 3/03545; G06F 3/0416
USPC 345/179

(57) ABSTRACT

A touch screen interfacing device may include a digit engaging portion, a setting portion arranged on the digit engaging portion, and a touching portion arranged in the setting portion and adapted for engaging a touch screen.

### FIELD OF THE INVENTION

The present disclosure relates generally to a touch screen interfacing device. More particularly, the present disclosure relates generally to a stylus device for interacting with a touch screen of a computing device. Still more particularly, the present disclosure relates to a capacitive stylus device arranged on a ring that can be worn on a finger or toe, for example.

### BACKGROUND

Touch screen devices come in several forms including resistive, capacitive, infrared grid, optical imaging, dispersive signal technology, and other technologies. These screens are often adapted for interaction with a user without the need for separate keyboard, mouse, or other input/output device. As such, touch screens allow a user to interact with a computing device by interacting directly with what is displayed on the screen. Depending on the sensing technology employed on a touch screen, the screens may typically be responsive to touch from a human finger, a stylus, a pen, or another pointing-type device.

In many cellular and smart phones, for example, a touch screen is employed offering the user a visual keyboard representation or a choice of icons, the selection of which allows a specific function to be performed or perhaps simply the input of a number or letter. These touch screens/keyboards may sense a finger or other selecting means in differing ways including but not limited to slight depression of the screen outer layer in individually predetermined coordinate locations; change in light or heat of the selecting means over similar locations; and an interruption of an electrostatic field that can be measured as a change in capacitance at a particular location. As these user interfaces have evolved over time, one of the preferred selecting means that has been readily accepted by consumers is the stylus.

Stylus devices for use in interacting with handheld devices or other touch screen-type devices have been used for some time and can be helpful for older people or those with larger fingers. The use of a stylus may be an alternative to voice texting, for example, which may be inaccurate and may be reliant on Wi-Fi and data networks, which are commonly unavailable. In some cases, a stylus may resemble a writing pen. That is, it may be generally elongate with a tapered tip. In the case of hand-held devices, in some cases, a stylus may be provided and intended to be used with the device. In some instances, the stylus may be tethered to the device and/or may have a storage compartment on the device for storing the stylus when not in use. Tethered styluses may be difficult to use due to the tether getting in the way or otherwise preventing free motion of the stylus. However, without a tether, the stylus may be misplaced or even lost.

### SUMMARY

In one embodiment, disclosed herein, a touch screen interfacing device may include, a digit engaging portion, a setting portion arranged on the digit engaging portion, and a touching portion arranged in the setting portion and adapted for engaging a touch screen. In some embodiments, the touching portion is rotatable. In some embodiments, the touching portion may be flexibly secured to the touching portion. In other embodiments, the device may further include an illumination element. In some embodiments, the digit engaging portion may be a band, such as a ring band. In some embodiments, the digit engaging portion may be a partial band.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION OF THE FIGURES

FIGS. 1A-1C show front, top, and side views, respectively, of a ring stylus, according to some embodiments.

FIGS. 2A-2C show front, top, and side views, respectively, of a ring stylus, according to some embodiments.

FIGS. 3A-3C show front, top, and side views, respectively, of a ring stylus, according to some embodiments.

FIGS. 4A-4C show front, top, and side views, respectively, of a ring stylus, according to some embodiments.

FIGS. 5A-5C show front, top, and side views, respectively, of a ring stylus, according to some embodiments.

FIG. 6 shows a cross-section view of a portion of the ring stylus of FIGS. 2A-2C, according to some embodiments.

FIG. 7 shows a ring stylus, according to some embodiments.

FIG. 8 shows a ring stylus, according to some embodiments.

FIG. 9 shows a ring stylus, according to some embodiments.

FIG. 10 shows yet another ring stylus, according to some embodiments.

FIG. 11 shows a necklace arrangement, according to some embodiments.

FIGS. 12A-12C show, respectively, an inverted view, an in-use palm-side view, and an in-use backhand-side view of the ring stylus of FIG. 4.

FIGS. 13A-13C show yet another embodiment of a ring stylus in an inverted view, an in-use palm-side view, and an in-use backhand-side view, respectively.

### DETAILED DESCRIPTION

The present disclosure, in some embodiments, is a ring stylus. The ring may be worn by a user and a portion of the ring may include a stylus for use in engaging a touch screen on a hand held device or other computing device. The ring may be worn on the tip of a user's finger, or alternatively, the ring may be worn in a typical position on a user's finger on the proximal phalange of the finger. Either way, the ring may be readily accessible and available for use in most circumstances. In the case of special needs users, the ring stylus may alternatively be worn on a toe, for example, or in some cases, the ring may be a pendant on a necklace, for example.

The stylus portion of the ring may be directed toward the palm side of the user's hand and the ring may be positioned near the tip of the finger and used similarly to the way the tip of the finger would be used to type on a hand held device or other touch screen. In some cases, the ring may be worn on the proximal phalange of the finger and the user may slip the ring toward the tip of their finger when using the ring to touch the screen. Where the stylus portion of the ring is directed outwardly, the user may rotate the ring such that the stylus portion is arranged on the palm side of the user's finger. The user may, thus, use the stylus similar to the way they would otherwise use their finger tip to touch the screen. In this case, the ring may be maintained in a secure position on the finger by securing the ring on the backside of the finger with an overlapping adjacent finger or by maintaining the user's fingers immediately adjacent to one another. In still other embodiments, the ring may be attached to a necklace, lanyard, belt, necktie, or other apparatus worn on a part of the body or as a part of clothing.

The ring stylus may be advantageous as being a wearable article and, thus, may commonly be present with the user and potentially less likely to be misplaced or lost when compared to pen-like styluses, for example. Moreover, the ring stylus may be easily accessible when needed and it may be free of tethers and other clumsy elements or devices that may interfere with the use of the stylus. Still further, while accessible and commonly present with the user, the appearance of the ring stylus may be generally pleasing or at least unobtrusive to the user or others because it is disguised as a ring, for example.

Referring now to FIGS. 1A-1C, a first embodiment of a touch screen interfacing device 100 is shown. As shown, the interfacing device 100 may be in the form of a hand ring and may be configured for use as a stylus to interact with a touch screen of a computing device. The device 100 may be generally pleasing, such as in ornamental jewelry or at least unobtrusive jewelry, or such as another wearable item. As shown, the interfacing device 100 may include a digit engaging portion 102, a setting portion 104, and a touching portion 106.

The digit engaging portion 102 may be configured for securing the device 100 to a human and, in particular, to a human digit such as a finger or toe. The digit engaging portion 102, may be in the form of a generally round, oval, or oblong shaped band configured for wrapping around the full circumference of a digit. The band may have an internal diameter adapted for receiving a digit therethrough and may have a size the same or similar to common ring sizes ranging from approximately size 0 to approximately size 16. Incremental sizes within the range and sizes outside the range may also be provided.

The internal diameter may define an inner surface 108 and the band may have an outer surface 110 offset from the inner surface by a thickness 112. The thickness 112 of the band may vary around the circumference of the ring or the thickness 112 may be substantially constant. In some embodiments as discussed with respect to FIGS. 4 and 5 below, the band may be adapted to fit around the partial circumference of a human digit and it may be generally pleasing such as in ornamental jewelry or at least unobtrusive jewelry. As shown in FIG. 1A, the thickness 112 of the band may be relatively small near the bottom of the ring and may increase gradually toward the top of the ring. For example, the thickness of the ring near the bottom may range from approximately 1/32″ to approximately ⅛″, or the thickness near the bottom may be approximately 1/16″ and the thickness of the ring near the top may range from approximately 1/16″ to approximately ½″, or the thickness near the top may be approximately 3/16″. Still other thicknesses of the ring may be provided and the ring may be thicker near the bottom and thinner near the top or thicker on the sides and thinner near the top and bottom or vice versa.

Several different side profiles may be provided while remaining within the scope of the digit engaging portion 102. For example, while the cross-section shown in FIG. 1A is generally round, still other cross-sections may be provide including square, triangular, trapezoidal, hexagonal, octagonal, or other shaped cross-sections and the cross-section of the inner surface 108 and outer surface 110 might not be the same.

The digit engaging portion may have a width 114 as shown in FIG. 1C that is substantially constant or the width 114 may vary. For example, in some embodiments, the width 114 of the digit engaging portion 102 may be narrower near the bottom and wider near the top. In some embodiments, the width 114 may range from approximately 1/16″ to approximately 1½″ or from approximately ⅛″ to approximately ½″ or the width may be approximately 3/16″.

While the digit engaging portion 102 has been described as a continuous band, other designs may include spiraling bands or partial bands as described with respect to FIGS. 4A-5C for example. Still other digit engaging portions 102 may be provided. Moreover, while described as being adapted for engaging a finger or toe of a user, where the device 100 is used in a necklace configuration, for example, the digit engaging portion 102 may be adapted to engage or secure to a necklace by being thinner and smaller, for example. Still other types of digit engaging portions 102 and uses thereof may be provided.

With continued reference to FIGS. 1A-1C, the setting portion 104 may be adapted to provide for a secure connection of the touching portion 102 to be described below. The setting portion 104 may be adapted to resemble common stone settings such as a bezel setting, a prong setting, or a tension setting, for example. In the present embodiment, the setting portion 104 may be most akin to or may most closely resemble a bezel setting where a portion of the setting extends around the full circumference of the stone. In the present embodiment, the setting portion 104 is an inverted truncated cone-shape and is positioned substantially at the top of the digit engaging portion 102 of the ring. The setting portion 104 be soldered or otherwise secured to the digit engaging portion 102. In some embodiments, the setting portion 104 may be integral with the digit engaging portion 102 such as when, for example, the digit engaging portion 102 and setting portion 104 are monolithically formed. The setting portion 104 may include a top surface for receiving the touching portion 106 of the device 100. In the present embodiment, the top surface of the setting portion 104 may be substantially flat and round forming the base of the truncated cone shape. In other embodiments, the top surface may be concave or convex or the surface may include an angular valley or peak shape. Still other shaped surfaces may be provided including a more true bezel type shape with a rim around the perimeter for engaging the perimeter of the touching portion 106, for example. In some embodiments, the top surface may be textured or the top surface may be smooth.

Still other shaped setting portions 104 may be provided and may be more or less apparent to a user than the setting portion of FIGS. 1A-1C. For example, in some embodiments, the setting portion 104 may be less substantial and may include a flattened surface of the digit engaging portion 102, for example. In still other embodiments, the setting portion 104 may be a groove, trough, hole, or other element of the digit engaging portion 102 that is adapted to secure the touching portion 106. In some embodiments, the setting portion 104 may be a portion of the surface of the digit engaging portion 102 where the touching portion 106 is secured. Still other more elaborate or simpler setting portions 104 may be provided.

With continued reference to FIGS. 1A-1C, the touching portion 106 may be secured to the setting portion 104 and may be configured for projecting from the setting portion 104 and further adapted for use in touching a touch screen and effecting a result. The touching portion 106 may be generally hemispherically shaped as shown wherein the flat portion of the hemispherical shape is secured to the securing portion 104 with an adhesive, for example, and the rounded portion of the hemispherical shape is directed outward from the securing portion 104. The generally hemispherical shape may be round when viewed from above as shown in FIG. 1B or it may be oblong, or it may be substantially oval, for example. In some embodiments, the touching portion 106 may have a width and/or length ranging from approximately ⅛″ to approximately ½″ or from approximately ¼″ to approximately ⅜″ or approximately 5/16″. In some embodiments, the securing portion 104 and the touching portion 106 may extend away from the inside surface of the ring (i.e., the height 116 of the setting and stone) a total distance of approximately ⅛″ to approximately ¾″ or approximately ¼″ to approximately ½″ or approximately ⅜″. Still other shapes of the touching portion 106 may be provided such as cone shapes with a tip, cylindrical shapes, pyramidal shapes, and the like. In some embodiments, the outer, or touching, surface of the touching portion may be sculpted to include facets resembling those of a cut stone, for example. Still other shapes and sizes of touching portion 106 may be provided.

The touching portion 106 may be made from one of several different materials. In some embodiments, the touching portion 106 may be adapted for use with a capacitive touch screen and the touching portion 106 may be made from a capacitive or conductive material such as conductive silicone. The touching portion 106 may also be made from a hybrid material, a polymer, a metallic material, natural material, elastomeric material, or rigid material. Still other materials now know or later developed may be used. The touching portion 106 may include a broad tip or a narrow tip and the tip shape and size may be selected and adapted based on performance characteristics with several differing types of touch screens. In some embodiments, the touching portion 106 may be adapted for use with a resistive touch screen or other type of touch screen. In the case of resistive touch screens, the touching portion 106 of the device may be tapered or pointed, for example, and may be made from one or more of several different materials. The particular material of the touching portion 106 and the size and shape of the touching portion may be selected to provide a suitable stylus for use with one or more different types of touch screens.

Referring now to FIGS. 2A-2C, another embodiment of a touch screen interfacing device 200 is shown. In this embodiment, the digit engaging portion 202 may be the same or similar to the device 100 shown in FIGS. 1A-1C. However, the setting portion 204 may configured for allowing rotation or other motion of the touching portion 206. For example, in one embodiment, the setting portion 204 may include a female receiver 218 such as a central bore 220 having a bulb 220 at a bottom thereof as shown in FIG. 6. The touching portion 206 may correspondingly include a male portion including a projecting portion having an enlarged tip such that the touching portion 206 may be secured to the setting portion 204, but may be substantially free to rotate about an axis of the bore 220, for example. As shown, the bottom of the touching portion 206 may include sloping or concave portions 222 leading from the periphery of the touching portion 206 along the bottom of the touching portion 206 to the projecting portion near the center thereby isolating the bottom surface of the touching portion 206 from the top surface of the setting portion 204. Accordingly, the bottom of the touching portion 206 may be substantially free from frictional engagement with the top surface of the setting portion 204. Other rotatable couplings allowing the touching portion 206 to rotate relative to the setting portion 204 may also be provided. In other embodiments, the separation provided by the sloping portions 222 may allow for tipping motions of the touching portion 206 and the touching portion may or may not be rotatable about the bore axis.

For example, in some embodiments, the touching portion 206 may be adapted for positioning relative to the setting portion 204 such that it may be adjusted based on a user's preference for touching a screen. That is, for example, some users have a natural tendency to touch a screen from a directly top down approach. Others prefer to the hold the screen at an angle tipping away from them causing them to touch the screen below their intended point of contact based on their angled perspective view of the screen. The touching portion 206 in this embodiment or other embodiments, may be tipped and or rotated relative to the setting portion 204 and held in that position to allow a user to adapt the device 200 to their approach to touching a screen allowing the use of the device 200 to be more tailored to a particular user's approach and to remain consistent for that approach. In this embodiment, for example, the touching portion 206 may include a central member 224 such as a wire or other malleable core. The central member 224 may be anchored in the setting portion 204 such as by extending downward into the bore 220 of FIG. 6 and it may extend upward from the bore 220 into the body of the touching portion 206. As such, when the touching portion 206 is tipped relative to the setting portion 204, the bore 220 may hold a portion of the central member 224 generally vertical while the repositioned touching portion 206 may cause a top portion of the central member 224 to bend to a position desired by the user. The central member 224, having been bent, may then hold the touching portion 206 in that position relative to the setting portion 204.

Referring now to FIGS. 3A-3C, another embodiment of a touch screen interfacing device 300 is shown. In this embodiment, a plurality of touching portions 306 and other elements may be provided on a digit engaging portion 302 of the device. For example, a touching portion 306A similar to that shown in FIGS. 1A-1C may be provided and an additional touching portion 306B may be provided that is similar to that of FIGS. 2A-2C. In still other embodiments, two touching portions 306A, 306B that are substantially the same may be provided. In addition, the device 300 may also include an illumination element 306C, for example.

As shown, an illumination element 306C may be provided on the device by placing an LED below a central stone, for example. In this embodiment, a stone may be set in a prong setting, for example, and an LED may be placed below the stone and adapted to shine through the stone when illuminated. While not shown, the LED may be electrically connected to a power a source and a switch in the form of a push button, pressure sensor, or other device may be provided for activating the LED. In still other embodiments, the stone may be omitted and a simple lens or other LED covering may be provided or the lens or covering may be omitted.

In some embodiments, the several touching elements 306A-306B and illumination elements 306C may be provided on a selector 326. For example, as shown in FIGS. 3B and 3C, the digit engaging portion 302 may include a selector 326 arranged there along and the setting portions 306 of each of the elements may be arranged on the selector 326. The selector 326 may be movable relative to the digit engaging portion 302 allowing the elements to be selected by moving them into the apex position of the ring, for example. The selector 326 may include an inset band, as shown, that is engaged with the digit engaging portion 302 with a sliding, ratcheted, or other selective engagement allowing the selector 326 to be selectively positioned relative to the digit engaging portion 302. In some embodiments, the selector 326 may slide freely along the digit engaging portion 302 or the selector 326 may have positions where the selector 326 may not move relative to the digit engaging portion 302 without some circumferential force being applied. In some embodiments, the position of the selector 326 may activate some elements and deactivate other elements. For example, contacts may be provided on the inside surface of the selector 326 and when rotated to a position where the contacts are in contact with an opposing contact on the digit engaging portion 302, an electrical signal may be allowed to pass thereby activating the element that is in communication with the contact such as an LED, for example. In other embodiments, current may be included by magnetic induction.

The selector 326 may be substantially rectangular in cross-section through the band or the selector may be trapezoidal so as to undercut a portion the digit engaging portion 302 to resist bowing outward of the selector 326, for example. Still other cross-sections and engagements of the selector 326 on the digit engaging portion 302 may be provided.

Referring now to FIGS. 4A-4C and FIGS. 5A-5C, additional embodiments of a touch screen interfacing device 400/500 are shown. In the embodiment shown in FIGS. 4A-4C, the setting portion 404 and the touching portion 406 may be the same or similar to those described with respect to FIGS. 1A-1C and the embodiment shown in FIGS. 5A-5C may have a setting portion 504 and touching portion 506 that is the same or similar to those described with respect to FIGS. 2A-2C. While not shown, the illumination element shown in FIGS. 3A-3C may also be provided in one or more of the embodiments shown in FIGS. 4A-5C.

In the embodiments of FIGS. 4A-5C, the digit engaging portion 402/502 may be a partial band in lieu of a full band. In this embodiment, the band may have a portion of the bottom of the band omitted and the side portions of the band may be shaped like prongs 428/528 for extending along the side of a finger or toe for lightly grasping the finger or toe from each side. The prongs may be terminated in a rounded or smooth edge or a bulb 430/530 may be provided as shown. In some embodiments, the material used for this type of device may be relatively flexible allowing the device to fit on a larger range of finger or toe sizes while still remaining secured thereto.

Although the invention has been described with reference to various embodiments, persons skilled in the art will recognize that changes may be made in form and detail without departing from the spirit and scope of the invention. For example, in some embodiments as may be described further below, while the devices have been shown in upright positions, the device may commonly be worn such that the touching portion X06 is directed toward the palm side of the hand. In these cases, decorative features including or not including stones may be provided on the opposing or backhand side of the ring as is common with finger and toe rings. In still other embodiments, a decorative feature may be provided around the touching portion or a decorative feature may be provided with the touching portion arranged thereon. In some embodiments, the decorative feature may include a floral or leaf design, or another sculpture type design may be provided. In still other embodiments, pearls or other gems may be provided. In still other embodiments, a perfume holding compartment may be provide with the touching portion on top thereof or adjacent thereto. Still other combinations of the touching portion X06 with known designs and jewelry items may be provided.

Referring now to FIG. 7, yet another embodiment of touch screen interfacing device 700 is shown, according to some embodiments. In the embodiment shown, the device 700 includes a digit engaging portion 702 similar to that of FIGS. 1A-1C, for example, but the setting portion 704 of the ring may include a cluster arrangement. The cluster arrangement may include a plurality of pearls, for example, that may obscure the presence of a touching portion 706 arranged thereon. In other embodiments, the cluster may include a plurality of stones, metal features, or other ornamental creations. In some embodiments, the cluster may include a centrally located touching portion 706 that is arranged slightly above the other elements in the cluster so as to allow it to contact a flat touch screen surface without the surrounding cluster elements touching the screen. In other embodiments, as shown in FIG. 9, portions of the cluster 904 may include other touching portion elements such as differing types of touching portions such as the ones described with respect to FIGS. 3A-3C including positionable touching portions or illuminating elements and the like.

Referring now to FIG. 8, yet another embodiment of a touch screen interfacing device 800 is shown, according to some embodiments. In this embodiment, a ring style that may be used to hold or store solid perfume, lip gloss, or other material is shown. In some embodiments, as shown, the setting portion 804 may include an interior storage space 832 for holding the perfume or other material and the setting portion 804 may include a hinge 834, slidable, or otherwise openable or removable cover 836 such that the user may access the material in the interior storage area 832. In some embodiments, the cover may form the touching portion 806 of the ring stylus and the cover 836 may, thus, be adapted for contacting a touch screen, for example. In other embodiments, the cover 836 may include a decorative center with a raised perimeter forming the touching portion 806 and being adapted for touching a touch screen. In still further embodiments, the cover 836 may include an LED with a lens and a raised perimeter portion 806 for touching a touch screen.

Referring now to FIG. 10, still another embodiment is shown. In this embodiment, a ring is shown with an ornamental or jewelry-type feature on the top of the ring and a touching portion 1006 for engaging a touchscreen on a bottom portion opposite the top of the ring. In this embodiment, a user may wear the ring and have the stylus touching portion 1006 of the ring substantially secluded on the palm side of the user's hand. The ring may be worn near the base of the digit and may be slid toward the tip of the digit when the touching portion 1006 is to be used or the ring may be sized to be worn near the tip of the digit. Any type of touching portion 1006 including the several types described herein may be arranged on a ring opposite to an ornamental or other jewelry-type feature.

In addition, while the devices have been described as being in the form of a ring, it is to be appreciated that the same or similar devices may be suspended from a necklace and used in a similar manner. In some embodiments, the necklace may be an elastic material allowing the device to be stretched away from the neck and used with a touch screen device such as a handheld device or other touch screen device. In other embodiments, the necklace may include a retractability feature allowing the pendant to be extended away from the neck of the user. Still other variations and combinations of the elements described may be provided.

Referring now to FIG. 11, still another embodiment is shown. In this embodiment, a ring stylus (or pendant-type stylus) 1100 is shown suspended on a necklace 1138 such as a chain, cord, or other type of necklace 1138. In this embodiment, the ring or pendant-type stylus may be removed from the necklace 1138 for use, the necklace 1138 and pendant 1100 together may be removed from the user, or the necklace 1138 may be long enough to allow the touching portion 1106 of the ring or pendant 1100 type stylus to be used to touch a touch screen while connected thereto. In some embodiments, one or more retraction type devices 1140 may be provided to allow the necklace, lanyard, or other looping type device to extend its length allowing the ring-type or pendant-type stylus 1100 to be used at a distance away from the wearer's body. In still other embodiments, the necklace or lanyard 1138 may be stretchable such as by being made from stretchable material like elastic or elastomeric material, for example. By pulling on the stylus 1100 or other portion of the necklace 1138, the length of the necklace 1138 may be increased giving the ring stylus or pendant stylus 1100 a larger range of available motion relative to the user. Still other embodiments involving a ring-type or pendant-type stylus 1100 connected to various strings or ropes, or other retractable devices may be provided.

Turning now to FIGS. 12A-12C, the device 400 shown in FIGS. 4A-4C is shown in use on a user. The ring stylus may be worn with the touching portion 406 in the upright position on the back side of a user's hands. In other embodiments, as shown in FIGS. 12B and C the device 400 may be worn or adjusted such that the position of the touching portion 406 is on the palm side of the hand. In some embodiments, the size of the device 400 or ring may be selected such that the ring fits on the users digits near the tips of the digits, but is prevented from fitting further up the finger. In these embodiments, the users may wear the device 400 near the tip of their fingers and, thus, in a more readily usable position. In some embodiments, the band portion of the rings may be relatively flexible and sized to that the ring 400 may be worn on the narrower portion of a digit as well as on the thicker or larger portion of the digit. The ring may be worn on any of the digits of the hands or feet and the touching portion 406 may be adapted to interrupt an electromagnetic field of a touchscreen so as to allow a user to interact with, for example, a capacitive type touch screen or another type of touch screen.

Turning now to FIGS. 13A-13C, the device 1200 shown includes a band 1202 similar to that shown in FIGS. 4A-4C and 12A-12C. However, in this embodiment, the band 1202 may be partially helical allowing the returning portions of the ring to extend adjacent to one another and forming a full circle when viewed from the side as shown in FIG. 13A. In this embodiment, the user may wear the ring 1200 near the base of a digit, as shown in FIG. 13B and FIG. 13C, or the user may wear the ring near the tip of the digit. The user may also wear the ring 1200 so as to place the touching portion 1206 in proper position for touching a touch screen. In this embodiment, as shown in FIG. 13C, when the touching portion 1206 is positioned toward the palm side of the hand, the helically extending portions of the band may display a somewhat ornamental feature on the back side of the hand. Like the embodiment of FIG. 10, other types or ornamental features may be provided opposite the touching portion of the ring stylus 1200.

Although the invention has been described with reference to various embodiments, persons skilled in the art will recognize that changes may be made in form and detail without departing from the spirit and scope of the invention.

What is claimed is:

1. A touch screen interfacing device, comprising:
a digit engaging portion;
a setting portion arranged on the digit engaging portion; and
a touching portion arranged in the setting portion and adapted for engaging a touch screen.

2. The device of claim 1, wherein the touching portion is rotatable.

3. The device of claim 1, wherein the touching portion is flexibly secured to the touching portion.

4. The device of claim 1, further comprising an illumination element.

5. The device of claim 1, wherein the digit engaging portion is a band.

6. The device of claim 5, wherein the digit engaging portion is a ring band.

7. The device of claim 1, wherein the digit engaging portion is a partial band.

8. The device of claim 1, wherein the setting portion comprises a plurality of ornamental features and the touching portion is arranged thereon.

9. The device of claim 8, wherein the plurality of ornamental features are arranged in a cluster formation.

10. The device of claim 1, wherein the setting portion includes a storage space and the touching portion comprises a cover for the storage space.

11. The device of claim 10, wherein the cover includes a raised perimeter adapted for touching a touch screen.

12. The device of claim 1, wherein the touching portion includes a plurality of touching portion features arranged on the digit engaging portion in a cluster.

13. The device of claim 1, wherein the device comprise another setting portion arranged on a portion of the digit engaging portion opposite the setting portion, the another setting portion having an ornamental jewelry item arranged thereon.

14. The device of claim 13, wherein the ornamental jewelry item includes a stone arranged in the another setting portion.

15. The device of claim 14, further comprising a necklace looped through the digit engaging portion and adapted to suspend the device from a user's neck.

16. The device of claim 15, wherein the necklace is expandable.

17. The device of claim 16, wherein the necklace is expandable by stretching.

18. The device of claim 16, wherein the necklace is expandable by a retractability device.

19. The device of claim 1, wherein the digit engaging portion includes a helical portion.
